(19) United States
(12) Patent Application Publication
(10) Pub. No.: US 2024/0010891 A1
(43) Pub. Date: Jan. 11, 2024

(54) ADHESIVE TWO-COMPONENT COMPOSITION BASED ON ITACONATE MONOMER

(71) Applicant: BOSTIK SA, Colombes (FR)

(72) Inventor: Guillaume MICHAUD, LYON (FR)

(21) Appl. No.: 18/252,965

(22) PCT Filed: Nov. 29, 2021
(86) PCT No.: PCT/FR2021/052127

§ 371 Date: May 15, 2023

(30) Foreign Application Priority Data
Dec. 1, 2020 (FR) FR2012462

(51) Int. Cl. C09J 175/16; C08K 5/14

(52) U.S. Cl. CPC C09J 175/16; C08K 5/14

(57) ABSTRACT

The present invention relates to a two-component adhesive composition comprising:
a component A comprising:
   at least one polyurethane P comprising at least two (meth)acrylate end functions;
   at least one reducing agent; and
   at least one itaconate monomer of following formula (1):

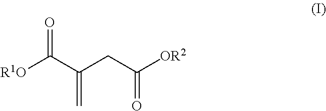

wherein each of R¹ and R² represents, independently of one another, organic radicals;
   at least one core-shell impact modifier;
a component B comprising:
   at least one oxidizing agent; and
   optionally at least one (meth)acrylate monomer M1.

### FIELD OF THE INVENTION

The present invention relates to a two-component, itaconate-monomer-based adhesive composition.

The invention also relates to the use of said composition in the repair and/or the structural or semi-structural adhesive bonding of materials in the transportation, motor vehicle (car, bus or truck), marine, assembly, electronics, battery or construction field

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Acrylates and methacrylates, in particular those with alkyl radicals, are monomers with a high vapor pressure. As a result, that they are odorous when applied.

Alternatives to these components have been developed. However, these alternative compositions do not make it possible to obtain good adhesive and/or mechanical properties.

There is therefore a need for new compositions which have both low odor and good mechanical properties (such as, for example, good adhesion properties).

### DESCRIPTION OF THE INVENTION

In the present application, unless otherwise indicated:
the amounts expressed in the percentage form correspond to weight/weight percentages;
the hydroxyl number of an alcoholic compound represents the number of hydroxyl functions per gram of product, which is expressed in the form of the equivalent number of milligrams of potassium hydroxide (mg KOH/g) used in the quantitative determination of the hydroxyl functions, per gram of product;
the viscosity measurement at 23° C. (or at 100° C.) may be performed using a Brookfield viscometer according to the standard ISO 2555. Typically, the measurement taken at 23° C. (or at 100° C.) may be performed using a Brookfield RVT viscometer with a spindle suitable for the viscosity range and at a rotational speed of 20 revolutions per minute (rpm).

### Composition

The present invention relates to a two-component adhesive composition comprising:
a component A comprising:
   at least one polyurethane P comprising at least two (meth)acrylate end functions;
   at least one reducing agent; and
   at least one itaconate monomer of following formula (I):

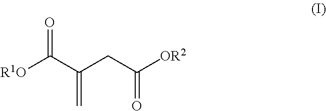

wherein each of R¹ and R² represents, independently of one another, organic radicals;
   at least one impact modifier having a core-shell-type structure (or core-shell impact modifier);
a component B comprising:
   at least one oxidizing agent; and
   optionally at least one (meth)acrylate monomer M1.

### Component A

### Polyurethane P

The polyurethane P may have a number-average molecular weight (Mn) greater than or equal to 700 g/mol, preferably greater than or equal to 900 g/mol.

The polyurethane P may have a number-average molecular weight (Mn) less than or equal to 30 000 g/mol, preferentially less than or equal to 10 000 g/mol, even more preferentially less than or equal to 5000 g/mol.

According to one preferred embodiment, the polyurethane P has a number-average molecular weight (Mn) ranging from 700 g/mol to 30 000 g/mol, preferentially from 900 g/mol to 20 000 g/mol, and even more preferentially from 900 g/mol to 10 000 g/mol.

The Mn of the polyurethane is measured by GPC with comparison with a PS reference.

The polyurethane P can be obtained via a process comprising:
E1) a step of preparing a polyurethane comprising at least two NCO end groups comprising the polyaddition reaction between:
   i) at least one polyisocyanate; and
   ii) at least one polyol;
E2) reacting the product formed on conclusion of step E1) with at least one (meth)acrylate monomer M2 comprising at least one hydroxyl function.

Polyisocyanate(s)

The polyisocyanate(s) which can be used can be added sequentially or reacted in the form of a mixture.

The polyisocyanate(s) can be chosen from diisocyanates or triisocyanates.

The polyisocyanate(s) can be monomer(s), oligomer(s) or polymer(s).

The polyisocyanate(s) can be chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 2,4′-methylenebis(cyclohexyl isocyanate) (2,4′-H6MDI), 4,4′-methylenebis(cyclohexyl isocyanate) (4,4′-H6MDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), bis(isocyanatomethyl)cyclohexane (H6-XDI) (in particular 1,3-bis(isocyanatomethyl)cyclohexane (1,3-H6-XDI)), xylylene diisocyanate (XDI) (in particular m-xylylene diisocyanate (m-XDI)), toluene diisocyanate (in particular toluene-2,4-diisocyanate (2,4-TDI) and/or toluene-2,6-diisocyanate (2,6-TDI)), diphenylmethane diisocyanate (in particular diphenylmethane-4,4′-diisocyanate (4,4′-MDI) and/or diphenylmethane-2,4′-diisocyanate (2,4′-MDI)), tetramethylxylylene diisocyanate (TMXDI) (in particular tetramethyl-m-xylylene diisocyanate), an HDI allophanate having, for example, the following formula (Y):

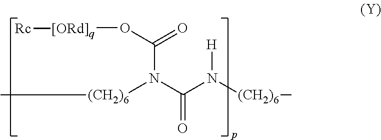

wherein p is an integer ranging from 1 to 2, q is an integer ranging from 0 to 9 and preferably from 2 to 5, R_{c} represents a saturated or unsaturated, cyclic or acyclic, linear or branched, hydrocarbon-based chain comprising from 1 to 20 carbon atoms, preferably from 6 to 14 carbon atoms, and Rd represents a linear or branched divalent alkylene group having from 2 to 4 carbon atoms, and preferably a divalent propylene group;
and mixtures thereof.

The polyisocyanate(s) that can be used can be triisocyanate(s), for example chosen from isocyanurates, biurets, and adducts of diisocyanates and of triols.

The isocyanurate(s) can be used in the form of a technical mixture of (poly)isocyanurate(s) with a purity of greater than or equal to 70% by weight of isocyanurate(s).

The diisocyanate isocyanurate(s) which can be used according to the invention can correspond to the following general formula (W):

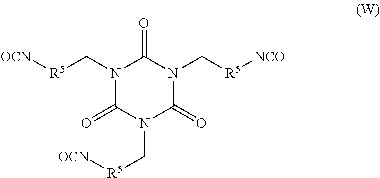

wherein R⁵ represents a linear or branched, cyclic, aliphatic, arylaliphatic or aromatic alkylene group comprising from 4 to 9 carbon atoms, with the proviso that the NCO groups are not connected by a covalent bond to a carbon atom forming part of an aromatic hydrocarbon-based ring, such as a phenyl group.

By way of example of diisocyanate trimers that can be used, mention may be made of the isocyanurate trimer of hexamethylene diisocyanate (HDI).

Mention may be made, as examples of adducts of diisocyanates and of triols which can be used according to the invention, of the adduct of meta-xylylene diisocyanate and of trimethyl olpropane, as represented below. This adduct is sold, for example, by Mitsui Chemicals, Inc. under the name Takenate® D-110N.

Usable polyisocyanate(s) is (are) typically commercially available. By way of example, mention may be made of Scuranate® TX sold by Vencorex, corresponding to a 2,4-TDI with a purity of about 95%, Scuranate® T100 sold by Vencorex, corresponding to a 2,4-TDI with a purity of greater than 99% by weight.

Polyol(s)

The polyol(s) can be chosen from polyester polyols, polyether polyols, polyene polyols, polycarbonate polyols, poly(ether-carbonate) polyols and mixtures thereof.

The polyol(s) that can be used can be chosen from aromatic polyols, aliphatic polyols, arylaliphatic polyols and the mixtures of these compounds.

The polyol(s) which can be used can be chosen from that (those) having a number-average molecular weight (Mn) ranging from 200 g/mol to 20 000 g/mol, preferably from 400 g/mol to 18 000 g/mol.

The number-average molecular weight of the polyols can be calculated from the hydroxyl number (OHN), expressed in mg KOH/g, and from the functionality of the polyol or determined by methods well known to those skilled in the art, for example by size exclusion chromatography (or SEC) with PEG (polyethylene glycol) standard.

Among the polyester polyols, mention may be made, for example, of polyester polyols of natural origin, such as castor oil; polyester polyols resulting from polycondensation:
of one or more aliphatic (linear, branched or cyclic) or aromatic polyols, such as, for example, monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, a polyether polyol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer and mixtures thereof, with
one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or a lactone.

The aforementioned polyester polyols may be prepared conventionally and are for the most part commercially available.

The polyether polyol(s) that may be used according to the invention can be chosen from polyoxyalkylene polyols, the linear or branched alkylene portion of which comprises from 1 to 4 carbon atoms, more preferentially from 2 to 3 carbon atoms.

By way of example of polyoxyalkylene diols or triols that can be used according to the invention, mention may be made of polyoxypropylene diols or triols (also denoted polypropylene glycol (PPG) diols or triols) having a number-average molecular weight (Mn) ranging from 300 to 12 000 g/mol; polyoxyethylene diols or triols (also denoted polyethylene glycol (PEG) diols or triols) having a number-average molecular weight (Mn) ranging from 300 to 12 000 g/mol; and mixtures thereof.

By way of example of a polyester diol, mention may be made of Voranol® P1010 sold by Dow, having a number-average molecular weight (Mn) in the vicinity of 1020 g/mol and the hydroxyl number of which is approximately 110 mg KOH/g. As examples of polyether triols, mention may be made of the polyoxypropylene triol sold under the name Voranol® CP 450 by Dow, having a number-average molecular weight (Mn) in the vicinity of 450 g/mol and the hydroxyl number of which ranges from 370 to 396 mg KOH/g.

Mention may be made, as examples of polyene polyols, of saturated or unsaturated butadiene homopolymers comprising hydroxyl end groups, which are optionally epoxidized, such as, for example, those sold under the name Poly BD® or Krasol® by Cray Valley, and also saturated or unsaturated isoprene homopolymers, comprising hydroxyl end groups, such as for example those sold under the name Poly IP™ or EPOL™ by Idemitsu Kosan.

By way of example of a polycarbonate diol, mention may be made of Converge® Polyol 212-10 and Converge® Polyol 212-20 sold by Novomer, having respective number-average molecular weights (Mₙ) equal to 1000 and 2000 g/mol, the hydroxyl numbers of which are, respectively, 112 and 56 mg KOH/g,

Monomer(s) M2

The (meth)acrylate monomer M2 can be chosen from hydroxyalkyl (meth)acrylates.

Preferably, the (meth)acrylate monomer M2 is chosen from 2-hydroxyethyl methacrylate (HEMA), 2-hydroxypropyl methacrylate, 4-hydroxybutyl methacrylate, 2-hydroxybutyl methacrylate, 2-hydroxyethyl acrylate (HEA), 2-hydroxypropyl acrylate (HPA), 4-hydroxybutyl acrylate (4-HBA) (for example available from Sartomer or BASF).

Step E1)

The polyaddition reaction E1) can be carried out at a temperature preferably of less than 95° C. and/or under preferably anhydrous conditions. The polyaddition reaction can be carried out in the presence or absence of at least one catalyst. The reaction catalyst(s) which can be used during the polyaddition reaction can be any catalyst known to those skilled in the art for catalyzing the formation of polyurethane by reaction of at least one polyisocyanate with at least one polyol. The polyaddition reaction E1) can be carried out in the presence or absence of at least one solvent. The solvent can be chosen from solvents which do not react with the reactive functions of the ingredients used in step E1). It can, for example, be methyl methacrylate, toluene, ethyl acetate, xylene and mixtures thereof.

Step E2)

Step E2) can be carried out at a temperature preferably of less than 80° C., preferentially less than or equal to 60° C., and/or under preferably anhydrous conditions. Step E2) can be carried out in the presence or absence of at least one catalyst. It can be the same catalyst as that used in step E1). Step E2) can be carried out in the presence or absence of at least one solvent. The solvent can be chosen from solvents which do not react with the reactive functions of the ingredients used in step E2). It can, for example, be methyl methacrylate, toluene, ethyl acetate, xylene and mixtures thereof. Preferably, step E2) is carried out by addition of the monomer(s) M2 to the reaction medium of step E1), without isolation of the product formed in step E1).

The polyurethane P according to the invention may also be commercially available. Mention may be made, for example, of CN® 981 (polyurethane-acrylate having an Mn of 2200 g/mol, and an acrylate functionality of 2), CN® 9210 (polyurethane-acrylate having an Mn of 1500 g/mol, and an acrylate functionality of 6), CN® 9165A (polyurethane-acrylate having an Mn of 900 g/mol, and an acrylate functionality of 6), sold by Sartomer.

According to one embodiment, the polyurethane P comprises at least three (meth)acrylate functions, preferably six (meth)acrylate functions.

According to one embodiment, the polyurethane P does not comprise any epoxy functions.

According to one embodiment, the component A comprises at least two polyurethanes P comprising at least two (meth)acrylate end functions. Preferably, the component A comprises a polyurethane P1 comprising two (meth)acrylate end functions and a polyurethane P2 (different than P1) comprising more than two (meth)acrylate end functions (more preferentially six (meth)acrylate end functions).

The total content of polyurethane(s) P in the component A can be less than or equal to 50% by weight, preferably less than or equal to 40% by weight.

The total content of polyurethane(s) P in the component A may be greater than or equal to 5% by weight, preferably greater than or equal to 10% by weight, and even more preferentially greater than or equal to 20% by weight relative to the total weight of the component A.

Reducing Agent

The reducing agent can be chosen from tertiary amines, sodium metabisulfite, sodium bisulfite, transition metals, alpha-aminosulfones, and mixtures thereof.

The reducing agent may be contained in the aforementioned polyurethane P. This embodiment is for example possible when, in step E1) mentioned above, the polyols and the polyisocyanates are reacted with a tertiary amine having pendent hydroxyl functions, such as for example Bisomer® PTE sold by GEO Specialty Chemicals or else N-(2-hydroxyethyl)-N-methylaniline or else N-(2-hydroxyethyl)-N-methyl-p-toluidine.

Among the alpha-sulfones, mention may for example be made of bis(tolylsulfonymethyl)benzylamine.

Among the tertiary amines, mention may for example be made of diisopropanol-p-toluidine (DIIPT); dimethyl-p-toluidine; dipropoxy-p-toluidine; dimethylaniline; N,N-dimethylaminomethylphenol; N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; N,N-diethyl-p-bromoaniline; the following amines of formula (B) or (C):

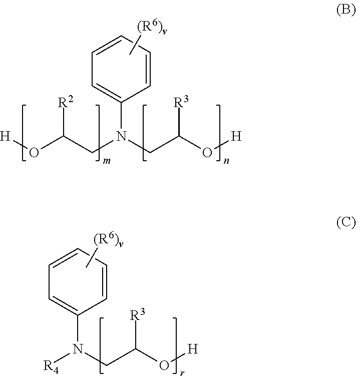

wherein:
   m and n are, independently of one another, an integer ranging from 1 to 150, preferably from 1 to 100, preferentially from 1 to 72, advantageously from 1 to 36, more advantageously still from 1 to 18;
   r is an integer ranging from 1 to 200, preferably from 1 to 104, preferentially from 1 to 72, advantageously from 1 to 36;
   R⁶ represents a radical chosen from the group consisting of a saturated or unsaturated and linear or branched alkyl comprising from 1 to 20 carbon atoms, preferably from 1 to 10 carbon atoms; of a (hetero)aryl comprising from 6 to 12 carbon atoms; of a cycloalkyl comprising from 3 to 12 carbon atoms;
   v represents an integer ranging from 0 to 5;
   R⁷ and R³ represent, independently of one another, a halogen atom, a hydrogen atom or a linear or branched alkyl group comprising from 1 to 12 carbon atoms, said alkyl group being optionally interrupted by at least one oxygen atom;
   R⁴ represents a hydrogen atom, an arylalkyl group or a linear or branched alkyl group comprising from 1 to 20 carbon atoms, preferably an alkyl group comprising from 1 to 12 carbon atoms, advantageously from 1 to 6 carbon atoms;
   on the condition that m+n>2, preferably n+m>2.5.

Mention may be made, among the amines of formula (B), for example, of Bisomer® PTE (CAS number: 878391-30-1) sold by Geo Specialty Chemicals, Accelerator PT25E (CAS number: 878391-30-1) sold by Lanxess, N,N-bis(2-hydroxypropyl)-p-aniline (CAS number: 3077-13-2) available from Biosynth, N,N-bis(2-hydroxypropyl)-p-toluidine (CAS number: 38668-48-3) sold by BASF, Ethox ANA-10 (CAS number: 36356-83-9) available from Ethox Chemical.

Mention may be made, among the amines of formula (C), for example, of N-(2-hydroxyethyl)-N-methylaniline (CAS number: 93-90-3) available from Sigma-Aldrich and N-(2-hydroxyethyl)-N-methyl-p-toluidine (MHPT, CAS number: 2842-44-6) available from Parchem.

Preferably, the component A comprises at least one tertiary amine, and even more preferentially an amine of formula (B) mentioned above.

The component A may comprise a total content of reducing agent(s) ranging from 0.5% to 5%, preferably from 0.5% to 3%, by weight relative to the total weight of the component A.

### Itaconate Monomer

The component A according to the invention comprises at least one itaconate monomer of following formula (I):

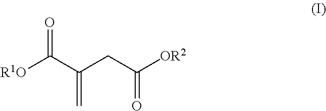

wherein each of R¹ and R² represents, independently of one another, organic radicals.

In formula (I) above, each of R¹ and R² may represent, independently of one another, an alkyl, an alkenyl, a cycloalkyl, a heterocycloalkyl, an aryl, a heteroaryl, an arylalkyl, a heteroarylalkyl, an alkylheteroaryl, or an alkylheterocycloalkyl, said groups possibly being substituted.

The aforementioned substituents can be chosen from alkyls, halogens, cycloalkyls, haloalkyls, halocycloalkyls, heteroaryls, aryls, heterocycloalkyls, alkoxys, alkylthios, hydroxyls, nitros, azidos, cyanos, acyloxys, carboxys or esters.

In the context of the invention, the term “alkyl” is understood to mean a linear or branched radical preferably comprising from 1 to 20 carbon atoms.

In the context of the invention, the term “alkenyl” is understood to mean a linear or branched hydrocarbon-based radical comprising at least one double bond, said radical preferably comprising from 2 to 20 carbon atoms. By way of example, mention may be made of propenyl, butenyl.

In the context of the invention, the term “arylalkyl” is understood to mean an alkyl group substituted by an aryl group, the arylalkyl group preferably comprising from 7 to 20 carbon atoms. As arylalkyl group, mention may be made, for example, of benzyl.

In the context of the invention, the term “heteroarylalkyl” is understood to mean an alkyl group substituted by a heteroaryl group, the heteroarylalkyl group preferably comprising from 7 to 20 carbon atoms.

In the context of the invention, the term “alkylheteroaryl” is understood to mean a heteroaryl group substituted by an alkyl group, said alkylheteroaryl group preferably comprising from 7 to 20 carbon atoms and at least one heteroatom.

In the context of the invention, the term “alkylheterocycloalkyl” is understood to mean a heterocycloalkyl group substituted by an alkyl group, said alkylheterocycloalkyl group preferably comprising from 4 to 20 carbon atoms and at least one heteroatom.

In the context of the invention, the term “aryl” is understood to mean a monocyclic or bicyclic aromatic radical preferably comprising from 6 to 12 carbon atoms. Mention may be made, for example, of phenyl.

In the context of the invention, the term “heteroaryl” is understood to mean a monocyclic or bicyclic aromatic radical comprising at least one heteroatom such as for example O, S or N, and preferably comprising from 4 to 12 carbon atoms. Mention may be made, for example, of the furanyl, thiophenyl, pyrrolyl, pyridinyl, indolyl or imidazolyl radicals.

In the context of the invention, the term “cycloalkyl” is understood to mean a saturated, monocyclic or polycyclic, preferably monocyclic or bicyclic, system preferably comprising from 3 to 12 carbon atoms, the rings possibly being bridged or fused in pairs, such as the cyclopropyl, cyclopentyl, cyclohexyl or else norbornyl groups.

In the context of the invention, the term “heterocycloalkyl” is understood to mean a saturated, monocyclic or polycyclic, preferably monocyclic or bicyclic, system preferably comprising from 3 to 12 carbon atoms and at least one heteroatom such as for example O or N, the rings possibly being bridged or fused in pairs.

According to one preferred embodiment, in the aforementioned formula (I), each of R¹ and R² represents, independently of one another, a C₁-C₁₅ alkyl, C₂-C₁₅ alkenyl, halo(C₁-C₁₅)alkyl, C₃-C₁₂ cycloalkyl or halo(C₃-C₁₂)cycloalkyl group, a heterocycle, an aryl, a heteroaryl, or an alkoxy(C₁-C₁₅)alkyl, each of which may optionally be substituted by at least one of the following radicals: C₁-C₁₅ alkyl, halo(C₁-C₁₅ alkyl), C₃-C₁₂ cycloalkyl, halo(C₃-C₁₂ cycloalkyl), heterocycle, aryl, heteroaryl, C₁-C₁₅ alkoxy, C₁-C₁₅ alkylthio, halo, hydroxyl, nitro, azido, cyano, acyloxy, carboxy or ester.

Preferably, in formula (I) above, each of R¹ and R² represents, independently of one another, a methyl, an ethyl, an n-propyl, an isopropyl, an n-butyl, a tert-butyl, a cyclopentyl, a cyclohexyl, a cyclohexylmethyl, a phenyl, a benzyl, a 2-phenylethyl, and an isobornyl.

Preferably, the itaconate of formula (I) is chosen from dimethyl itaconate, diethyl itaconate, di-n-butyl itaconate, di-isobutyl itaconate, dicyclohexyl itaconate, bis(hexafluoroisopropyl) itaconate, diphenyl itaconate, dibenzyl itaconate, ethylisobornyl itaconate, ethylcyclohexyl itaconate, and mixtures thereof. Even more preferentially, the itaconate of formula (I) is dimethyl itaconate or dibutyl itaconate.

According to the invention, the total content of itaconate monomer(s) of formula (I) in the component A may be greater than 40% by weight, preferably greater than or equal to 45% by weight relative to the total weight of the component A.

The monomers of formula (I) can be obtained by processes as for example described in WO201 5181310, which are in particular fermentation processes.

The monomers of formula (I) are advantageously biobased.

### Impact Modifier Having a Core-Shell-Type Structure

The impact modifier having a core-shell-type structure is typically known as a “core-shell impact modifier”.

Impact modifiers are well known to those skilled in the art, and comprise in particular core-shell impact modifiers.

The core-shell impact modifiers may be in the form of spherical particles. The weight average particle size (diameter) can range from 40 nm to 900 nm, preferably from 80 to 500 nm. The particle size can be measured with a Zetasizer (Malvern).

The core-shell impact modifier can be obtained by any process known to those skilled in the art, for example by a multistep process as described in FR 3 052 169 or in EP 2 465 884. In particular, the polymer is prepared by emulsion polymerization.

The core of the impact modifier may comprise a polymer L1 chosen from isoprene homopolymers, butadiene homopolymers, isoprene-butadiene copolymers, isoprene copolymers with a vinyl monomer, and butadiene copolymers with a vinyl monomer. The vinyl monomer can be chosen from styrene, alkylstyrene, acrylonitrile, alkyl (meth)acrylates, butadiene or isoprene.

The shell may comprise a polymer L2 obtained from (meth)acrylic monomers such as, for example, those chosen from C₁-C₁₂ alkyl (meth)acrylates. In particular, the shell comprises a polymer L2 obtained from C₁-C₄ alkyl methacrylate monomers and/or C₁-C₈ alkyl acrylate monomers.

Preferably, the shell comprises a polymer L2 obtained from methyl acrylate, propyl acrylate, isopropyl acrylate, butyl acrylate, methyl methacrylate, ethyl methacrylate, butyl methacrylate, and mixtures thereof.

According to one embodiment, the core-shell impact modifier comprises:
a core comprising a polymer L1 which is a butadiene-styrene copolymer;
a shell comprising a polymer L2 which is a poly(methyl methacrylate) (PMMA).

The core-shell impact modifiers may be commercially available. Mention may be made, for example, of Clearstrength® (for example Clearstrength® XT100) or the Durastrength® products sold by Arkema. Mention may also be made of the Paraloids (Paraloid 2650A, Paraloid 2691A) sold by Dow Corning.

According to the invention, the total content of polymer(s) having a core-shell-type structure in the component A can range from 2% to 20% by weight, preferably from 5% to 20% by weight, and even more preferentially from 10% to 18% by weight relative to the total weight of the component A.

### Component B

### Oxidizing Agent

The oxidizing agent can be chosen from peroxides, organic salts of transition metals, compounds containing a labile chlorine, and mixtures thereof.

The peroxide can be chosen from organic peroxides, inorganic peroxides and mixtures thereof.

Mention may be made, among the inorganic peroxides, of peroxydisulfuric acid and its salts, such as ammonium peroxodisulfate, sodium peroxodisulfate and potassium peroxodisulfate.

Mention may be made, among the organic peroxides, of cumene hydroperoxide, para-menthane hydroperoxide, tert-butyl peroxyisobutyrate, tert-butyl peroxybenzoate, tert-butyl peroxyneodecanoate, tert-amyl peroxypivalate, acetyl peroxide, benzoyl peroxide, dibenzoyl peroxide, 1,3-bis(t-butylperoxyisopropyl)benzene, diacetyl peroxide, t-butylcumyl peroxide, tert-butyl peroxyacetate, cumyl peroxide, 2,5-dimethyl-2,5-di(t-butylperoxy)hexane, 2,5-dimethyl-2,5-di(t-butylperoxy)hex-3-yne, 4-methyl-2,2-di(t-butylperoxy)pentane and mixtures thereof.

Preferably, the component B comprises benzoyl peroxide.

The component B may comprise a total content of reducing agent greater than or equal to 20% by weight, preferably greater than or equal to 30% by weight, advantageously greater than or equal to 35% by weight relative to the total weight of the component B.

The composition according to the invention can typically comprise a redox system, a reducing agent which is included in part A and an oxidizing agent which is included in part B. Mention may for example be made of the following combinations:
persulfates (oxidizing agent)/(sodium metabisulfite and/or sodium bisulfite) (reducing agents);
organic peroxides (oxidizing agent)/tertiary amines (reducing agent);
organic hydroperoxides (oxidizing agent)/transition metals (reducing agent);
H₂O₂ (oxidizing agent)/Iron (reducing agent).

### (Meth)Acrylate Monomer M1

The component B may optionally comprise at least one (meth)acrylate monomer M1.

The (meth)acrylate monomers M1 can comprise one (monofunctional) or more (polyfunctional) (meth)acrylate functions.

The (meth)acrylate monomer(s) M1 can be chosen from the group consisting of:
compounds having the following formula (II):

CH₂═C(R⁸)—COOR⁹ (II)
wherein:
   R⁸ represents a hydrogen atom or an alkyl group comprising from 1 to 4 carbon atoms;
   R⁹ is chosen from the group consisting of alkyls, cycloalkyls, alkenyls, cycloalkenyls, alkylaryls, arylalkyls and aryls, it being possible for said alkyls, cycloalkyls, alkenyls, cycloalkenyls, alkylaryls, arylalkyls or aryls to be optionally substituted and/or interrupted by at least one silane, one silicone, one oxygen, one halogen, one carbonyl, one hydroxyl, one ester, one urea, one urethane, one carbonate, one amine, one amide, one sulfur, one sulfonate or one sulfone;
   polyethylene glycol di(meth)acrylates;
   tetrahydrofuran (meth)acrylates;
   hydroxypropyl (meth)acrylate;
   hexanediol di(meth)acrylate;
   trimethylolpropane tri(meth)acrylate;
   diethylene glycol di(meth)acrylate;
   triethylene glycol di(meth)acrylate;
   tetraethylene glycol di(meth)acrylate;
   dipropylene glycol di(meth)acrylate;
   di(pentamethylene glycol) di(meth)acrylate;
   diglyceryl tetra(meth)acrylate;
   tetramethylene di(meth)acrylate;
   ethylene di(meth)acrylate;
   bisphenol A mono- and di(meth)acrylates;
   bisphenol F mono- and di(meth)acrylates; and
   mixtures thereof.

According to one embodiment, the (meth)acrylate monomer M1 is chosen from methyl (meth)acrylate, ethyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (metha)crylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

### Composition

The two-component composition according to the invention can comprise at least one additive chosen from the group consisting of fillers, antioxidants, light stabilizers/UV absorbers, metal deactivators, antistatics, antifogging agents, foaming agents, biocides, plasticizers, lubricants, emulsifiers, dyes, pigments, rheological agents, impact modifiers, adhesion promoters, optical brighteners, flame retardants, antisweating agents, nucleating agents, solvents and mixtures thereof.

These additives can be present in the component A and/or the component B of the composition according to the invention.

As examples of plasticizers that may be used, mention may be made of any plasticizer usually used in the field of adhesives, for instance phthalates, benzoates, trimethylolpropane esters, trimethylolethane esters, trimethylolmethane esters, glycerol esters, pentaerythritol esters, naphthenic mineral oils, adipates, cyclohexyldicarboxylates, liquid paraffins, natural oils (optionally epoxidized), polypropylenes, polybutylenes, hydrogenated polyisoprenes, and mixtures thereof.

Preferably, use is made of:
diisodecyl phthalate, such as, for example, sold under the name Palatinol™ DIDP by BASF,
an ester of alkylsulfonic acid and of phenol, such as, for example, sold under the name Mesamoll® by Lanxess,
diisononyl 1,2-cyclohexanedicarboxylate, such as, for example, sold under the name Hexamoll Dinch® by BASF,
pentaerythritol tetravalerate, such as, for example, sold under the name Pevalen™ by Perstorp,
the epoxidized soya bean oil as for example sold under the name Vikoflex® 7170 by Arkema.

When it is present in the composition, the content of plasticizer can be greater than or equal to 1%, preferably greater than or equal to 3%, even more preferentially greater than or equal to 5% by weight relative to the total weight of said composition.

According to one preferred embodiment, the composition comprises at least one plasticizer, and even more preferentially at least in the component B.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica, such as, for example, sold under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac SLT sold by Arkema.

The composition according to the invention may also comprise at least one organic and/or mineral filler.

The mineral filler(s) that may be used is (are) advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

The filler(s) can be chosen from the group consisting of clay, quartz, carbonate fillers, kaolin, gypsum, clays, and mixtures thereof; preferentially, the filler(s) is (are) chosen from carbonate fillers, such as alkali or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly those made of calcium sodium borosilicate or of aluminosilicate.

When a solvent, in particular a volatile solvent, is present in the composition, its content is preferably less than or equal to 5% by weight, more preferably less than or equal to 3% by weight, relative to the total weight of the composition.

Preferably, the content of solvent(s) in the composition is between 0% and 5% by weight.

The composition can comprise an amount of from 0.1% to 3%, preferably from 1% to 3%, by weight of at least one UV stabilizer or antioxidant. These compounds are typically introduced to protect the composition from degradation resulting from a reaction with oxygen which is liable to be formed by the action of heat or light. These compounds may include primary antioxidants which trap free radicals. The primary antioxidants may be used alone or in combination with other secondary antioxidants or UV stabilizers. Mention may be made, for example, of Irganox® 1010, Irganox® B561, Irganox® 245, Irgafos® 168, Tinuvin® 328 or Tinuvin™ 770, which are sold by BASF.

According to one embodiment, the aforementioned adhesive composition does not comprise any photoinitiator.

According to one embodiment, the component A/component B volume ratio in the composition of the invention ranges from 20/1 to 1/1, preferentially from 10/1 to 1/1.

The aforementioned adhesive composition may have a Brookfield viscosity at 23° C. ranging from 20 000 mPa·s to 150 000 mPa·s, preferably from 30 000 mPa·s to 100 000 mPa·s, even more preferentially from 40 000 to 80 000 mPa·s According to one preferred embodiment, the aforementioned composition comprises:
a component A comprising:
   a total content of polyurethane(s) P as described above greater than or equal to 5% by weight;
   from 0.5% to 5% by weight of reducing agent(s);
   a total content of itaconate monomer of formula (I) greater than or equal to 40% by weight, preferably greater than or equal to 45% by weight;
   a total content of core-shell impact modifier ranging from 5 to 20% by weight;
      relative to the total weight of the component A;
a component B comprising:
   a total content of oxidizing agent(s) greater than or equal to 20% by weight; and
   a total content of plasticizer(s) greater than or equal to 40% by weight;
      relative to the total weight of the component B.

### Ready-for-Use Kit

The present invention also relates to a ready-for-use kit, comprising both the component A as defined above and the component B as defined above, packaged in two separate compartments. It can, for example, be a two-component cartridge.

Indeed, the composition according to the invention can be in a two-component form, for example within a ready-for-use kit, comprising both the component A in a first compartment or drum and the component B in a second compartment or drum, in proportions suitable for direct mixing of the two components, for example using a metering pump.

According to one embodiment of the invention, the kit additionally comprises one or more means making possible the mixing of the components A and B. Preferably, the mixing means are chosen from metering pumps or static mixers with a diameter suited to the amounts used.

### Uses of the Compositions

The present invention also relates to the use of a composition as defined above as adhesive, mastic or coating, preferably as adhesive.

The invention also relates to the use of said composition in the repair and/or the structural or semi-structural adhesive bonding of materials in the transportation, motor vehicle (car, bus or truck), assembly, marine, electronics, battery or construction field.

The present invention also relates to a process for assembling two substrates by adhesive bonding, comprising:
the coating, onto at least one of the two substrates to be assembled, of a composition obtained by mixing the components A and B as defined above; then
the effective bringing of the two substrates into contact;
the crosslinking of the composition.

The crosslinking step can be carried out at a temperature between 0° C. and 200° C., preferably between 10° C. and 150° C., preferably between 23° C. and 80° C. and in particular between 20° C. and 25° C.

The crosslinking can also be induced using microwaves.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The compositions according to the invention once lead advantageously, after crosslinking, to an adhesive seal having semi-structural or structural properties.

The compositions according to the invention advantageously exhibit, after crosslinking, good adhesive properties, while having a low or even zero odor.

The compositions are also advantageously of low toxicity compared to the usual acrylic compositions, due in particular to the use of itaconate monomer of formula (I), the toxicity of which is lower than that of the usual acrylics.

All the embodiments described above may be combined with one another. In particular, the various aforementioned constituents of the composition, and notably the preferred embodiments of the composition, may be combined with one another.

In the context of the invention, the term “of between x and y” or “ranging from x to y” is understood to mean an interval in which the limits x and y are included. For example, the range “between 0% and 25%” notably includes the values 0% and 25%.

The invention is now described in the following exemplary embodiments, which are given purely by way of illustration and should not be interpreted in order to limit the scope thereof.

### EXAMPLES

The following ingredients were used:
dimethyl itaconate sold by Aldrich;
dibutyl itaconate sold by Aldrich;
Bisomer PTE (CAS number: 103671-44-9) sold by GEO Specialty Chemicals;
SR9054 (CAS Number: 1628778-81-3) sold by Sartomer: difunctional acrylic acid adhesion promoter;
Aerosil® R202 (CAS number: 67762-90-7): a hydrophobic fumed silica (post-treated with PDMS) having a specific surface area (BET) equal to 100±20 m²/g, sold by Evonik;
MBS Clearstrength® XT100 sold by Arkema: a core-shell impact modifier based on MMA-butadiene-styrene;
Vikoflex® 7170 sold by Arkema is an epoxidized soybean oil used as a plasticizer;
Crayvallac® SLT sold by Arkema is a micronized amide wax used as rheological agent;
CN®981: urethane-acrylate with functionality 2 and Mn of 2200 g/mol, sold by Arkema;
CN®9210: urethane-acrylate with functionality 6 and Mn of 1500 g/mol, sold by Arkema;
CN®9165 A: urethane-acrylate with functionality 6 and Mn of 900 g/mol, sold by Arkema;
Mesamoll®: ester of alkylsulfonic acid and of phenol, sold by Lanxess;
methacrylic acid sold by Aldrich;
Peroxan BP 50: 50% benzoyl peroxide paste sold by Pergan.

### Example 1: Preparation of Compositions No. 1 and No. 2

The various ingredients constituting the component A are mixed in the proportions shown in the following table, at a temperature of 2300, in a reactor kept constantly stirred and under nitrogen.

The various ingredients constituting the component B are mixed in the proportions shown in the following table, at a temperature of 2300, in a reactor kept constantly stirred and under nitrogen.

Composition No. 1

| Component A | | Component B | |
|---|---|---|---|
| | % by weight | | % by weight |
| | (relative to the | | (relative to the |
| Ingredients | total weight of A) | Ingredients | total weight of B) |
| dibutyl | 46 | Peroxan | 40 |
| itaconate | | BPO | |
| XT100 | 17 | Mesamoll | 55 |
| CN981 | 20 | Crayvallac | 5 |
| | | STL | |
| CN9210 | 10 | | |
| Methacrylic acid | 1 | | |
| SR9054 | 1 | | |
| HDK N20 | 4 | | |
| Bisomer PTE | 1 | | |
| TOTAL | 100 | TOTAL | 100 |

Composition No. 2

| Component A | | Component B | |
|---|---|---|---|
| | % by weight | | % by weight |
| | (relative to the | | (relative to the |
| Ingredients | total weight of A) | Ingredients | total weight of B) |
| dimethyl | 47 | Peroxan | 40 |
| itaconate | | BPO | |
| XT100 | 15 | Mesamoll | 55 |
| CN981 | 10 | Crayvallac | 5 |
| | | STL | |
| CN9165A | 20 | | |
| Methacrylic | 1 | | |
| acid | | | |
| SR9054 | 1 | | |
| HDK N20 | 4 | | |
| Bisomer PTE | 2 | | |
| TOTAL | 100 | TOTAL | 100 |

The component A and the component B above (for each composition) were mixed, in a volume ratio of 10:1 (A:B).

The mixing is carried out at a temperature of approximately 2300, according to the given ratio by volume, with a static mixer.

### Example 2: Results

### Measurement of the Breaking Strength by Tensile Testing:

The measurement of the strength (tensile strength) by tensile testing was performed according to the protocol described below.

The principle of the measurement consists in drawing, in a tensile testing device, the movable jaw of which moves at a constant rate equal to 200 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 37 of 2011. The narrow part of the dumbbell used has a length of 20 mm, a width of 4 mm and a thickness of 500 μm.

Adhesive bonding Tests

The adhesive bondings are produced on strips made of aluminum (anodized or 6060) originating from Rocholl. An area of 25×12.5 mm was delimited on a strip using wedges made of Teflon with a thickness of 250 μm. This area was filled with the test composition and then a second strip of the same material was laminated. The combination was held by a clamp and placed in a climate-controlled chamber at 23° C. or at 100° C. and 50% RH (relative humidity) for a week before tensile testing on a universal testing machine. The aim of the tensile testing on a universal testing machine is to evaluate the maximum force (in MPa) to be exerted on the assemblage in order to separate it. Recourse to a tensile testing device makes it possible to subject a simple lap joint placed between two rigid supports to a shear stress up to failure by exerting tension on the supports parallel to the surface of the assemblage and to the main axis of the test specimen. The result to be recorded is the breaking force or stress. The shear stress is applied via the movable jaw of the tensile testing device with a displacement at the rate of 5 mm/min. This tensile testing method is carried out as defined by the standard EN 1465 of 2009.

The properties obtained for the compositions prepared are summarized in the table below:

| | Adhesive bonding at 23° C. | | Test specimen H2 |
|---|---|---|---|
| | force at | | tensile strength |
| Composition | break (MPa) | Substrate | (MPa) |
| Composition | 9 | Anodized | 12 |
| No. 1 | | aluminum | |
| Composition | 11 | Aluminum | 25 |
| No. 2 | | 6060 | |

Compositions No. 1 and No. 2 according to the invention advantageously result in an adhesive seal having, after crosslinking, a high tensile strength (12 and 25 MPa respectively).

In addition, compositions No. 1 and No. 2 advantageously result in forces at break of 9 and 11 MPa respectively for adhesive bonding on anodized aluminum, demonstrating good adhesion.

1-15. (canceled)

16. A two-component adhesive composition comprising:
a component A comprising:
at least one polyurethane P comprising at least two (meth)acrylate end functions;
at least one reducing agent; and
at least one itaconate monomer of following formula (I): 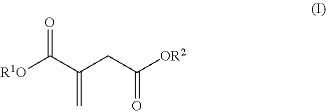
wherein each of R¹ and R² represents, independently of one another, organic radicals;
at least one core-shell impact modifier; and
a component B comprising:
at least one oxidizing agent; and
optionally at least one (meth)acrylate monomer M1.

17. The adhesive composition as claimed in claim 16, characterized in that the Brookfield viscosity at 23° C. ranges from 20 000 mPa·s to 150 000 mPa·s.

18. The adhesive composition as claimed in claim 16, characterized in that, in formula (I), each of R¹ and R² represents, independently of one another, an alkyl, an alkenyl, a cycloalkyl, a heterocycloalkyl, an aryl, a heteroaryl, an arylalkyl, a heteroarylalkyl, an alkylheteroaryl, or an alkylheterocycloalkyl, said groups possibly being substituted.

19. The adhesive composition as claimed in claim 16, characterized in that each of R¹ and R² represents, independently of one another, a C₁-C₁₅ alkyl, C₂-C₁₅ alkenyl, halo(C₁-Cis)alkyl, C₃-C₁₂ cycloalkyl or halo(C₃-C₁₂)cycloalkyl group, a heterocycle, an aryl, a heteroaryl, or an alkoxy(C₁-Cis)alkyl, each of which may optionally be substituted by at least one of the following radicals: C₁-C₁₅ alkyl, halo(C₁-C₁₅ alkyl), C₃₋₁₂ cycloalkyl, halo(C₃-C₁₂ cycloalkyl), heterocycle, aryl, heteroaryl, C₁-C₁₅ alkoxy, C₁-C₁₅ alkylthio, halo, hydroxyl, nitro, azido, cyano, acyloxy, carboxy or ester.

20. The adhesive composition as claimed in claim 16, characterized in that the itaconate of formula (I) is selected from the group consisting of dimethyl itaconate, diethyl itaconate, di-n-butyl itaconate, di-isobutyl itaconate, dicyclohexyl itaconate, bis(hexafluoroisopropyl) itaconate, diphenyl itaconate, dibenzyl itaconate, ethylisobornyl itaconate, ethylcyclohexyl itaconate, and mixtures thereof.

21. The adhesive composition as claimed in claim 16, characterized in that the total content of itaconate monomer(s) of formula (I) in the component A is greater than 40% by weight, relative to the total weight of the component A.

22. The adhesive composition as claimed in claim 16, characterized in that the polyurethane P has a number-average molecular weight (Mn) greater than or equal to 700 g/mol.

23. The adhesive composition as claimed in claim 16, characterized in that the polyurethane P comprises at least three (meth)acrylate functions.

24. The composition as claimed in claim 16, characterized in that the total content of polyurethane(s) P in the component A is less than or equal to 50% by weight relative to the total weight of the component A.

25. The composition as claimed in claim 16, characterized in that the component A comprises a polyurethane P1 comprising two (meth)acrylate end functions and a polyurethane P2 (different than P1) comprising more than two (meth)acrylate end functions.

26. The composition as claimed in claim 16, characterized in that the core of the core-shell impact modifier comprises a polymer L1 selected from the group consisting of isoprene homopolymers, butadiene homopolymers, copolymers of isoprene-butadiene, copolymers of isoprene with a vinyl monomer, and copolymers of butadiene with a vinyl monomer.

27. The composition as claimed in claim 16, characterized in that the shell of the core-shell impact modifier comprises a polymer L2 obtained from (meth)acrylic monomers.

28. The composition as claimed in claim 16, characterized in that the component A/component B volume ratio in the composition of the invention ranges from 20/1 to 1/1.

29. A ready-for-use kit comprising both the component A as defined in claim 16 and the component B as defined in claim 16, packaged in two separate compartments.
